(19) United States
(12) Patent Application Publication
(10) Pub. No.: US 2017/0097784 A1
(43) Pub. Date: Apr. 6, 2017

(54) STORAGE CONTROL DEVICE

(71) Applicant: FUJITSU LIMITED, Kawasaki-shi (JP)

(72) Inventor: Makoto IIDA, Kawasaki (JP)

(73) Assignee: FUJITSU LIMITED, Kawasaki-shi (JP)

(21) Appl. No.: 15/269,177

(22) Filed: Sep. 19, 2016

(30) Foreign Application Priority Data
Oct. 1, 2015 (JP) 2015-196115

(51) Int. Cl. G06F 3/06

(52) U.S. Cl. CPC G06F 3/0619; G06F 3/0616; G06F 3/0647; G06F 3/0653; G06F 3/0683

(57) ABSTRACT

A storage control device includes a memory and a processor. The memory stores first information about a cumulative amount of data which has been written into a plurality of storage devices respectively. The plurality of storage devices have a limit in a cumulative amount of data which is capable to be written into the respective storage devices. The processor selects a first storage group from the plurality of storage groups on basis of the first information. The processor selects a second storage group from the plurality of storage groups. The processor exchanges data of a first storage device which belongs to the first storage group and data of a second storage device which belongs to the second storage group with each other. The processor causes the first storage device to belong to the second storage group and causes the second storage device to belong to the first storage group.

### CROSS-REFERENCE TO RELATED APPLICATION

This application is based upon and claims the benefit of priority from the prior Japanese Patent Application No. 2015-196115, filed on Oct. 1, 2015, the entire contents of which are incorporated herein by reference.

### FIELD

The embodiments discussed herein are related to a storage control device.

### BACKGROUND

A hard disk drive (HDD) and a solid state drive (SSD) are widely used as a storage device storing data which is handled by a computer. In a system requiring a data reliability, in order to suppress a data loss or a work suspension arising from a failure of a storage device, a redundant array of inexpensive disks (RAID) device is used in which a plurality of storage devices are coupled with each other for a redundancy.

Recently, a RAID device (SSD-RAID device) in which a plurality of SSDs are combined with each other has also been used. Due to a limit in the number of times for writing in a flash memory, an SSD has an upper limit in a cumulative amount of data (writable data) which is capable to be written into the SSD. Hence, an SSD which has reached the upper limit of amount of writable data is no longer used. When a plurality of SSDs reach the upper limit of amount of writable data at the same time, an SSD-RAID device may lose the redundancy.

In order to avoid this circumstance, a technology has been suggested as to replacing an SSD which exceeds a threshold value for the number of writing times with a spare disk. Also, a technology has been suggested as to copying data of a consumed SSD to a spare storage medium when a value calculated based on a consumption value indicating a consumption degree of an SSD and the upper limit of amount of writable data exceeds a threshold value.

Related techniques are disclosed in, for example, Japanese Laid-Open Patent Publication No. 2013-206151 and Japanese Laid-Open Patent Publication No. 2008-040713.

When the above-described technologies are applied, it is possible to avoid the risk of the simultaneous occurrence of failures in the SSDs in advance. However, in the suggested technologies, since an SSD that has been consumed to some extent is replaced with a spare SSD, the SSD to be replaced is removed from the RAID and no longer used, despite that the lifetime thereof has not yet expired.

Replacing an SSD prior to the expiration of the lifetime thereof causes an increase in the replacement frequency, thereby increasing operation costs. However, in the suggested technologies, when the threshold value is set to delay the replacement timing to the time when the number of writing times is close to the upper limit, it increases the risk of the redundancy loss of the SSD-RAID device due to the multiple failures of the SSDs.

Hence, it is required to conceive a method which suppresses the simultaneous occurrence of failures in a plurality of SSDs, rather than a method which preparatorily avoids the occurrence of a failure in each SSD constituting the RAID due to the limit in writing. When this method is implemented, it is possible to maintain the reliability of the SSD-RAID device while continuing to operate the SSDs for as long time as possible.

### SUMMARY

According to an aspect of the present invention, provided is a storage control device including a memory and a processor. The memory is configured to store therein first information about a cumulative amount of data which has been written into a plurality of storage devices respectively. The plurality of storage devices have a limit in a cumulative amount of data which is capable to be written into the respective storage devices. The plurality of storage devices are grouped into a plurality of storage groups. The processor is coupled with the memory. The processor is configured to select a first storage group from the plurality of storage groups on basis of the first information. The processor is configured to select a second storage group from the plurality of storage groups. The second storage group is different from the first storage group. The processor is configured to exchange data of a first storage device which belongs to the first storage group and data of a second storage device which belongs to the second storage group with each other. The processor is configured to cause the first storage device to belong to the second storage group. The processor is configured to cause the second storage device to belong to the first storage group.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a storage control device according to a first embodiment;

FIG. 2 is a diagram illustrating an example of a storage system according to a second embodiment;

FIG. 3 is a diagram illustrating an exemplary hardware configuration of a host device according to the second embodiment;

FIG. 4 is a diagram illustrating an exemplary functional configuration of a storage control device according to the second embodiment;

FIG. 5 is a diagram illustrating an example of a RAID table according to the second embodiment;

FIG. 6 is a diagram illustrating an example of an SSD table according to the second embodiment;

FIG. 7 is a flowchart illustrating a flow of a table construction process according to the second embodiment;

FIG. 8 is a first flowchart illustrating a flow of processes for RAID groups in operation according to the second embodiment;

FIG. 9 is a second flowchart illustrating a flow of processes for RAID groups in operation according to the second embodiment;

FIG. 10 is a first flowchart illustrating a flow of a rearrangement process according to the second embodiment;

FIG. 11 is a second flowchart illustrating a flow of a rearrangement process according to the second embodiment;

FIG. 12 is a diagram illustrating an example of a RAID table according to a modification (Modification#1) of the second embodiment;

FIG. 13 is a first flowchart illustrating a flow of processes for RAID groups in operation according to a modification (Modification#1) of the second embodiment;

FIG. 14 is a second flowchart illustrating a flow of processes for RAID groups in operation according to a modification (Modification#1) of the second embodiment;

FIG. 15 is a third flowchart illustrating a flow of processes for RAID groups in operation according to a modification (Modification#1) of the second embodiment;

FIG. 16 is a first flowchart illustrating a flow of processes for RAID groups in operation according to a modification (Modification#2) of the second embodiment; and

FIG. 17 is a second flowchart illustrating a flow of processes for RAID groups in operation according to a modification (Modification#2) of the second embodiment.

### DESCRIPTION OF EMBODIMENTS

Hereinafter, embodiments of the present disclosure will be described with reference to the accompanying drawings. Throughout the descriptions and the drawings, components having a substantially identical function will be denoted by the same reference numeral, and thus, overlapping descriptions thereof will be omitted.

### First Embodiment

A first embodiment will be described.

The first embodiment relates to a storage system which manages a plurality of storage devices, each having an upper limit for a cumulative amount of writable data, by dividing the storage devices into a plurality of storage groups. In this storage system, when a predetermined condition based on a cumulative value of amount of written data is met, rearrangement of the storage devices is performed between the storage groups. Here, the rearrangement is a process of replacing data stored in a storage device of one storage group and data stored in a storage device of another storage group with each other, and then, trading the storage devices between the storage groups.

For example, by rearranging a storage device which has been consumed (a cumulative amount of written data is large) and a storage device which has been relatively less consumed, the number of storage devices which have been consumed in one storage group may be reduced. Although the storage device which has been consumed belongs to the other storage group as a result of the rearrangement, the risk of failure in the storage devices resulting from the consumption may be distributed among the storage groups. Since the storage devices which are different from each other in the consumption degree exist together in each storage group, the risk of the simultaneous occurrence of failures in the plurality of storage devices within a storage group may be reduced.

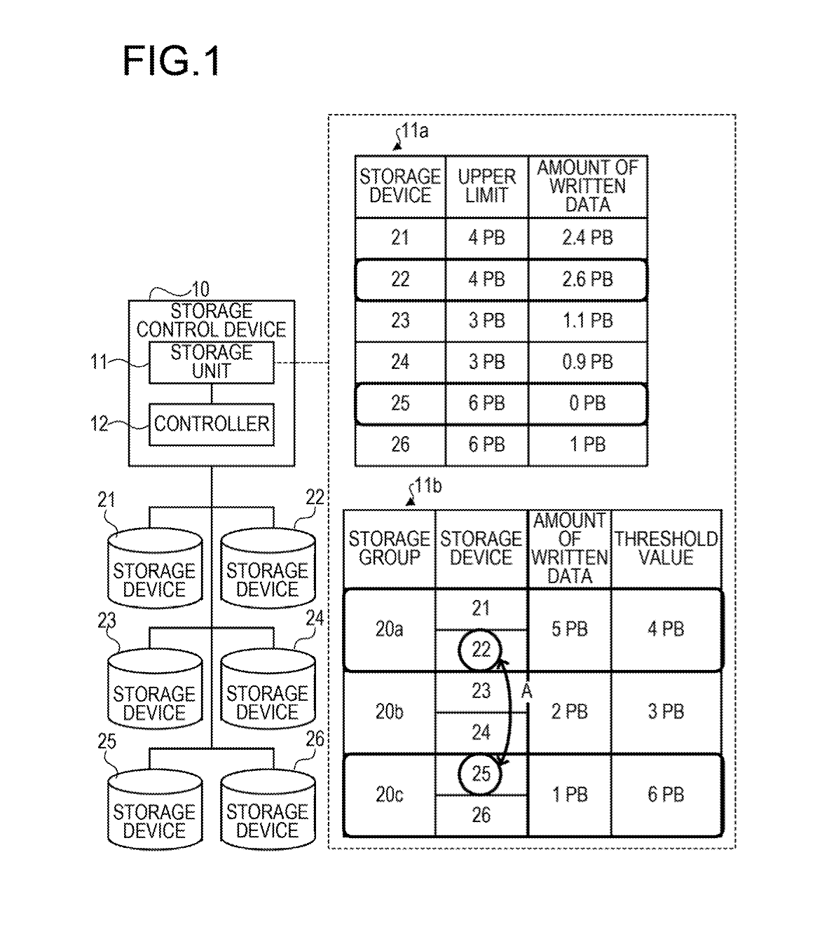

Hereinafter, a storage control device 10 will be described with reference to FIG. 1. The storage control device 10 illustrated in FIG. 1 is an example of a storage control device according to the first embodiment. FIG. 1 is a diagram illustrating an example of a storage control device according to the first embodiment.

The storage control device 10 includes a storage unit 11 and a controller 12.

The storage unit 11 is a volatile storage device such as a random access memory (RAM) or a nonvolatile storage device such as an HDD or a flash memory. The controller 12 is a processor such as a central processing unit (CPU) or a digital signal processor (DSP). The controller 12 may be an electronic circuit such as an application specific integrated circuit (ASIC) or a field programmable gate array (FPGA). The controller 12 executes a program stored in the storage unit 11 or another memory.

The storage control device 10 manages storage devices 21, 22, 23, 24, 25, and 26 each having an upper limit for a cumulative value of amount of written data, and storage groups 20a, 20b, and 20c to which the storage devices 21, 22, 23, 24, 25, and 26 belong. The SSDs are an example of the storage devices 21, 22, 23, 24, 25, and 26.

The storage unit 11 stores therein storage device information 11a to manage the storage devices 21, 22, 23, 24, 25, and 26. Further, the storage unit 11 stores therein storage group information 11b to manage the storage groups 20a, 20b, and 20c.

The storage device information 11a includes identification information for identifying a storage device (“Storage Device” column), an upper limit of a cumulative amount of writable data (“Upper Limit” column), and a cumulative value of an actual amount of written data (“Amount of Written Data” column). In the example of FIG. 1, for convenience of descriptions, the identification information is represented by the reference numerals. The cumulative value means a total amount of data which have ever been written in the storage device, including already erased data, and not an amount of data currently stored in the storage device.

According to the storage device information 11a illustrated in FIG. 1, as for the storage device 21, the upper limit of cumulative amount of writable data is 4 peta bytes (PB), and the cumulative value of the actual amount of written data is 2.4 PB. As for the storage device 22, the upper limit of cumulative amount of writable data is 4 PB, and the cumulative value of the actual amount of written data is 2.6 PB. When comparing the storage devices 21 and 22 with each other, the cumulative value of amount of written data for the storage device 22 is close to the upper limit, as compared to that of the storage device 21. That is, the storage device 22 is exhausted as compared to the storage device 21.

An exhaustion degree of each storage device may be quantified by using an exhaustion rate represented in the equation (1) below. The exhaustion rate may be an index to evaluate the likelihood of the risk that a failure occurs in the storage devices resulting from the cumulative value of amount of written data reaching the upper limit.

Exhaustion rate=cumulative value of amount of written data/upper limit (1)

The storage group information 11b includes identification information for identifying a storage group (“Storage Group” column), and identification information for identifying a storage device which belongs to the storage group (“Storage Device” column). Further, the storage group information 11b includes a cumulative value of amount of data written in a storage group (“Amount of Written Data” column), and a threshold value which is used to determine whether or not to perform a rearrangement to be described later (“Threshold Value” column).

A storage group is a group of storage devices, in which one virtual storage area is defined. For example, a RAID group which is a group of storage devices constituting a RAID is an example of the storage group. For a RAID group, a logical volume which is identified by a logical unit number (LUN) is set. The technology of the first embodiment is favorably used for a storage group which is managed in a redundant manner such as in the various RAID systems (except for RAID0) which are tolerant of a failure in a part of storage devices.

According to the storage group information 11b illustrated in FIG. 1, the storage devices 21 and 22 belong to the storage group 20a. The cumulative value of amount of written data in the storage group 20a is 5 PB. This amount of written data is a total cumulative value of amount of written data for the storage devices which belong to the storage group. The threshold value is set based on upper limits of the storage devices which belong to the storage group. The threshold value is set to, for example, 50% of a sum of the upper limits of the storage devices which belong to the storage group.

The controller 12 selects a first storage group (e.g., the storage group 20a) from the plurality of storage groups 20a, 20b, and 20c on the basis of a predetermined condition for the amount of written data. For example, the predetermined condition requires that a cumulative value of amount of written data for a storage group be larger than the threshold value.

The controller 12 selects a second storage group, which is different from the first storage group (e.g., the storage group 20a), from the plurality of storage groups 20a, 20b, and 20c. At this time, for example, the controller 12 selects the storage group 20c having the smallest cumulative value of amount of written data, as the second storage group, with reference to the storage group information 11b.

The controller 12 replaces data of a first storage device (e.g., the storage device 22) which belongs to the first storage group (the storage group 20a) and data of a second storage device (e.g., the storage device 25) which belongs to the second storage group (the storage group 20c) with each other.

At this time, the controller 12 determines, for example, the storage device 22 exhibiting the largest exhaustion rate in the storage devices which belong to the first storage group (the storage group 20a), as the first storage device. Further, the controller 12 determines the storage device 25 exhibiting the smallest exhaustion rate in the storage devices which belong to the second storage group (the storage group 20c), as the second storage device. Then, the controller 12 replaces the data of the storage device 22 and the data of the storage device 25 with each other.

In addition, the controller 12 causes the first storage device (the storage device 22) to belong to the second storage group (the storage group 20c). Further, the controller 12 causes the second storage device (the storage device 25) to belong to the first storage group (the storage group 20a). That is, the controller 12 rearranges the first storage device (the storage device 22) and the second storage device (the storage device 25).

In the example of FIG. 1, as represented by the double-headed arrow A, the contents of the storage devices 22 and 25 are exchanged, and furthermore, the storage device 22 is caused to belong to the storage group 20c, and the storage device 25 is caused to belong to the storage group 20a, by the above-described rearrangement. As a result of the rearrangement, the burden of writing (the exhaustion degree of the storage devices) is distributed between the storage groups 20a and 20c. Accordingly, in the storage group 20a where writing has been concentrated, the risk of simultaneous occurrence of failures in the storage devices 21 and 22 resulting from the amount of writable data reaching the upper limit is reduced.

As described above, by monitoring the cumulative values of the amount of written data for the storage groups and the storage devices, and performing rearrangement of the storage devices between the storage groups on the basis of the cumulative values, it is possible to reduce the risk of multiple failures in the storage devices which belong to the same storage group. Even in the case where a RAID having a redundancy is set up, when a plurality of storage devices fail at the same time, data restoration may be difficult. However, when the technology of the first embodiment is applied, the risk of multiple failures in the storage devices may be reduced, thereby further improving the reliability.

The method of selecting the first and second storage groups is not limited to the above-described example. For example, it is possible to apply a method of calculating exhaustion rates of the storage groups and selecting a storage group exhibiting the largest exhaustion rate as the first storage group and a storage group exhibiting the smallest exhaustion rate as the second storage group. In addition, as the method of selecting the second storage group, it is be possible to apply a method of selecting an arbitrary storage group having a smaller cumulative value of amount of written data or exhaustion rate than that of the first storage group. This modification is also included in the technological scope of the first embodiment.

The first embodiment has been described.

### Second Embodiment

Subsequently, a second embodiment will be described.

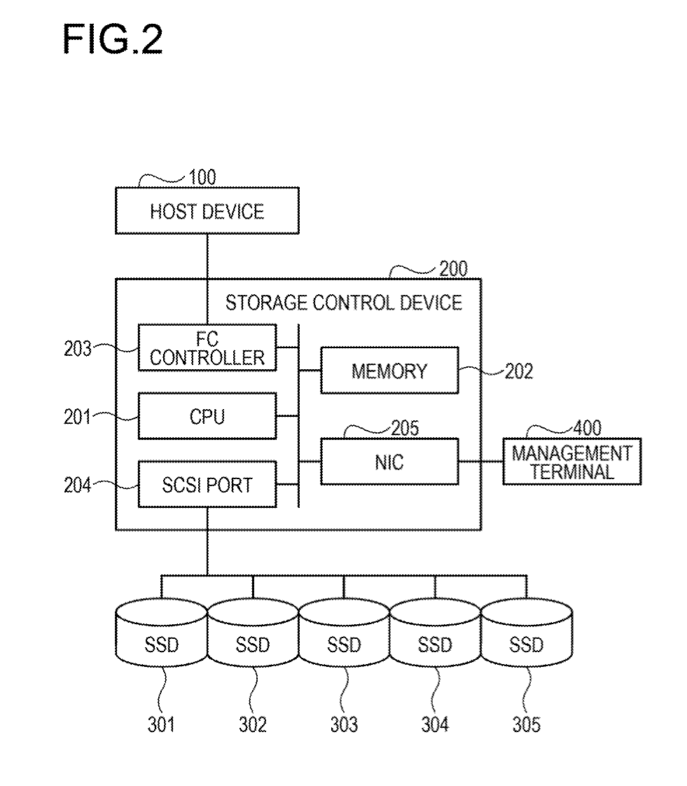

A storage system according to the second embodiment will be described with reference to FIG. 2. In the descriptions, the hardware configuration of each device according to the second embodiment will also be described. FIG. 2 is a diagram illustrating an example of a storage system according to the second embodiment.

As illustrated in FIG. 2, the storage system according to the second embodiment includes a host device 100, a storage control device 200, SSDs 301, 302, 303, 304, and 305, and a management terminal 400. The storage control device 200 is an example of a storage control device according to the second embodiment.

The host device 100 is a computer in which a business application or the like works. The host device 100 performs data writing and reading with respect to the SSDs 301, 302, 303, 304, and 305 through the storage control device 200.

When writing data, the host device 100 transmits a write command to the storage control device 200 to instruct writing of write data. When reading data, the host device 100 transmits a read command to the storage control device 200 to instruct reading of read data.

The host device 100 is coupled with the storage control device 200 through a fibre channel (FC). The storage control device 200 controls access to the SSDs 301, 302, 303, 304, and 305. The storage control device 200 includes a CPU 201, a memory 202, an FC controller 203, a small computer system interface (SCSI) port 204, and a network interface card (NIC) 205.

The CPU 201 controls the operation of the storage control device 200. The memory 202 is a volatile storage device such as a RAM or a nonvolatile storage device such as an HDD or a flash memory. The FC controller 203 is a communication interface coupled with, for example, a host bus adapter (HBA) of the host device 100 through the FC.

The SCSI port 204 is a device interface for connection to SCSI devices such as the SSDs 301, 302, 303, 304, and 305. The NIC 205 is a communication interface coupled with, for example, the management terminal 400 through a local area network (LAN).

The management terminal 400 is a computer used when performing, for example, the maintenance of the storage control device 200. The host device 100 may be coupled with the storage control device 200 through an FC fabric, or through other communication methods.

The SSDs 301, 302, 303, 304, and 305 may be SSDs adapted for systems other than the SCSI, and for example, SSDs adapted for a serial advanced technology attachment (SATA) system. In this case, the SSDs 301, 302, 303, 304, and 305 are coupled with a device interface (not illustrated) of the storage control device 200, which is adapted for the SATA system.

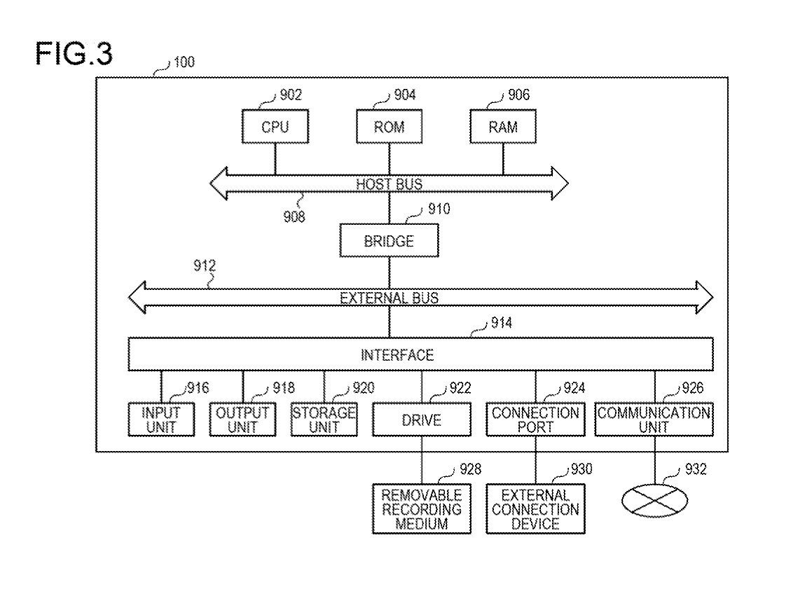

The hardware configuration of the host device 100 will be described with reference to FIG. 3. FIG. 3 is a diagram illustrating an exemplary hardware configuration of the host device according to the second embodiment.

Functions of the host device 100 may be implemented by using, for example, the hardware resources illustrated in FIG. 3. As illustrated in FIG. 3, the hardware mainly includes a CPU 902, a read-only memory (ROM) 904, a RAM 906, a host bus 908, and a bridge 910. Further, the hardware includes an external bus 912, an interface 914, an input unit 916, an output unit 918, a storage unit 920, a drive 922, a connection port 924, and a communication unit 926.

The CPU 902 functions as, for example, an arithmetic processing device or a control device and executes various programs recorded in the ROM 904, the RAM 906, the storage unit 920, or a removable recording medium 928 so as to control the overall operation or a part of an operation of each component. The ROM 904 is an example of a storage device that stores therein, for example, a program to be executed by the CPU 902 or data used for an arithmetic operation. The RAM 906 temporarily or permanently stores therein, for example, a program to be executed by the CPU 902 or various parameters which vary when the program is executed.

These components are coupled with each other through, for example, the host bus 908 capable of transmitting data at a high speed. The host bus 908 is coupled with the external bus 912, which transmits data at a relatively low speed, through the bridge 910. As the input unit 916, for example, a mouse, a keyboard, a touch panel, a touch pad, a button, a switch, and a lever are used. Further, as the input unit 916, a remote controller which is capable of transmitting a control signal through infrared rays or other radio waves may be used.

As the output unit 918, a display device such as a cathode ray tube (CRT), a liquid crystal display (LCD), a plasma display panel (PDP), or an electro-luminescence display (ELD) is used. Further, as the output unit 918, an audio output device such as a speaker, or a printer may be used.

The storage unit 920 is a device that stores therein various data. As the storage unit 920, a magnetic storage device such as an HDD is used. Further, as the storage unit 920, a semiconductor storage device such as an SSD or a RAM disk, an optical storage device, or an optical magnetic storage device may be used.

The drive 922 is a device that reads information written in the removable recording medium 928 or writes information in the removable recording medium 928. As the removable recording medium 928, for example, a magnetic disk, an optical disk, an optical magnetic disk, or a semiconductor memory is used.

The connection port 924 is a port configured for connection of an external connection device 930 thereto, such as a universal serial bus (USB) port, an IEEE 1394 port, a SCSI, an FC-HBA or an RS-232C port. The communication unit 926 is a communication device configured to be coupled with a network 932. As the communication unit 926, for example, a communication circuit for a wired or wireless LAN or a communication circuit or a router for optical communication is used. The network 932 which is coupled with the communication unit 926 is, for example, the Internet or a LAN.

Functions of the management terminal 400 may be also implemented by using all or a part of the hardware exemplified in FIG. 3.

The storage system according to the second embodiment has been described.

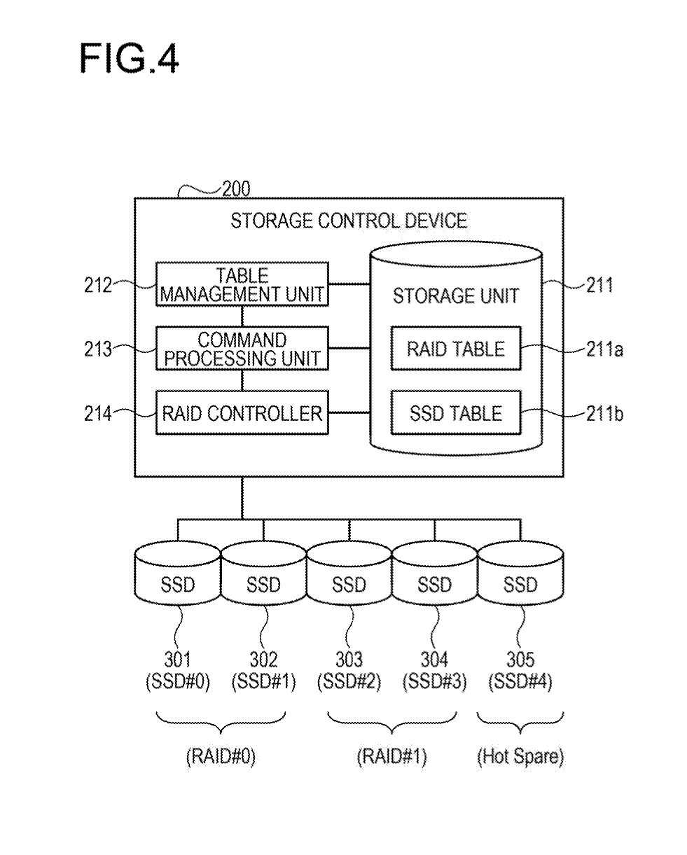

Subsequently, the functions of the storage control device 200 will be described with reference to FIG. 4. FIG. 4 is a diagram illustrating an exemplary functional configuration of the storage control device according to the second embodiment.

As illustrated in FIG. 4, the storage control device 200 includes a storage unit 211, a table management unit 212, a command processing unit 213, and a RAID controller 214. The storage unit 211 may be implemented by the above-described memory 202. The table management unit 212, the command processing unit 213, and the RAID controller 214 may be implemented by the CPU 201.

Hereinafter, for convenience of descriptions, the SSDs 301, 302, 303, 304, and 305 may be referred to as SSD#0, SSD#1, SSD#2, SSD#3, and SSD#4, respectively. In addition, it is assumed that two RAID groups RAID#0 and RAID#1 are set and that one SSD (the SSD 305) is used as a spare disk (hot spare (HS)).

The storage unit 211 stores therein a RAID table 211a and an SSD table 211b. The RAID table 211a stores therein information about the RAID groups set for the SSDs 301, 302, 303, 304, and 305. The SSD table 211b stores therein information about the SSDs 301, 302, 303, 304, and 305.

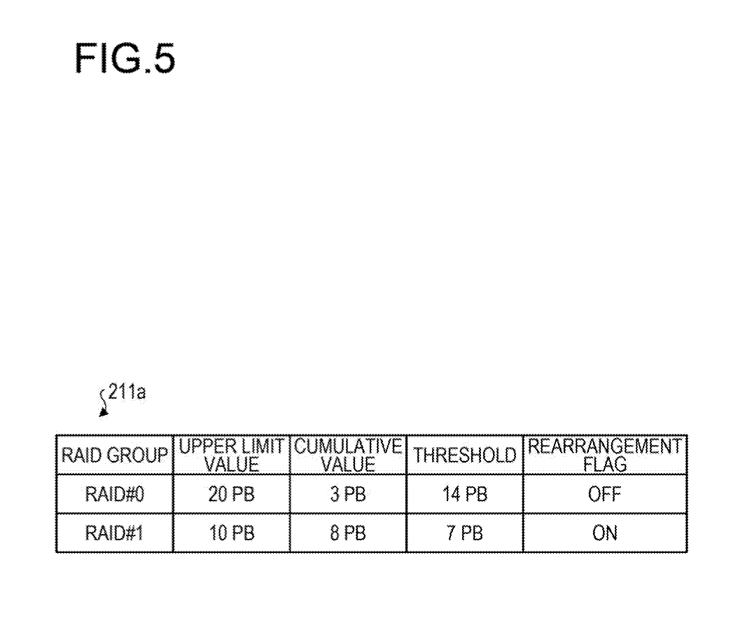

Here, the RAID table 211a will be further described with reference to FIG. 5. FIG. 5 is a diagram illustrating an exemplary RAID table according to the second embodiment.

As illustrated in FIG. 5, the RAID table 211a includes identification information for identifying a RAID group (“RAID Group” column) and an upper limit value of amount of writable data in the RAID group (“Upper Limit Value” column). The upper limit value included in the RAID table 211a is obtained by summing up the upper limit values of the SSDs which belong to the relevant RAID group.

Further, the RAID table 211a includes a cumulative value of an actual amount of written data (“Cumulative Value” column) and a threshold value used to determine whether or not to perform the rearrangement of the SSDs (“Threshold” column).

The cumulative value included in the RAID table 211a is obtained by summing up cumulative values of the SSDs which belong to the relevant RAID group. The threshold value is set based on the upper limit value. The threshold value exemplified in FIG. 5 is set to 70% of the upper limit value. The setting of the threshold value may be arbitrarily determined based on, for example, a concentration degree of access to the RAID groups or reliability expected from the RAID groups.

Further, the RAID table 211a includes a rearrangement flag that indicates whether the relevant RAID group is to be rearranged (“Rearrangement Flag” column).

The rearrangement process includes copying data of an SSD. Hence, from a view point of extending the lifetime of the SSDs or reducing the processing load, it is beneficial to not overly increase the frequency of performing the rearrangement. Thus, the second embodiment suggests a method in which a RAID group to be rearranged is predetermined and performs the rearrangement for the predetermined RAID group at a predetermined timing. The rearrangement flag is information indicating a RAID group to be rearranged.

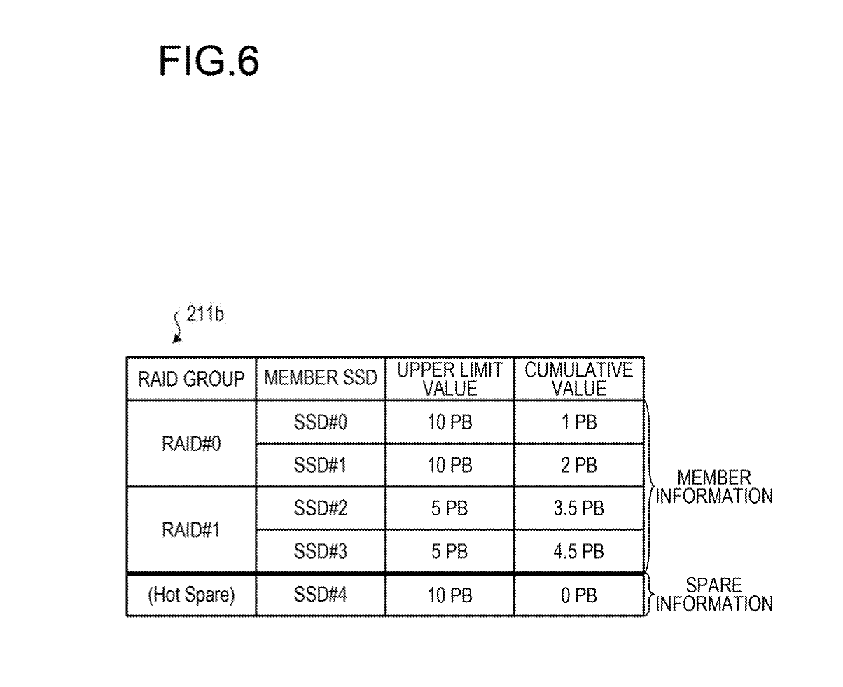

Subsequently, the SSD table 211b will be further described with reference to FIG. 6. FIG. 6 is a diagram illustrating an exemplary SSD table according to the second embodiment.

As illustrated in FIG. 6, the SSD table 211b includes identification information for identifying a RAID group (“RAID Group” column) and identification information for identifying an SSD (member SSD) which belongs to the relevant RAID group (“Member SSD” column). Further, the SSD table 211b includes an upper limit value of amount of writable data (“Upper Limit Value” column) and a cumulative value of an actual amount of written data (“Cumulative Value” column) in each SSD.

For example, in the example of FIG. 6, SSD 301 (SSD#0) and SSD 302 (SSD#1) belong to the RAID group RAID#0 as member SSDs. The upper limit value of the SSD 301 (SSD#0) is 10 PB, and the cumulative value thereof is 1 PB. The upper limit value of the SSD 302 (SSD#1) is 10 PB, and the cumulative value thereof is 2 PB. Accordingly, the upper limit value of the RAID group is 20 PB (see FIG. 5), and the cumulative value thereof is 3 PB.

In the example of FIG. 6, the SSD table 211b further includes information (spare information) about the HS. The spare information may be managed separately from the SSD table 211b. Hereinafter, for convenience of descriptions, it is assumed that the spare information is included in the SSD table 211b. Among the information included in the SSD table 211b, the information about the member SSDs which belong to the RAID groups may be referred to as “member information”.

Reference is made to FIG. 4 again. The table management unit 212 performs processes such as generation and update of the RAID table 211a and the SSD table 211b. For example, when a new SSD is added to a RAID group, the table management unit 212 associates the added SSD with the RAID group and stores information of an upper limit value acquired from the SSD in the SSD table 211b.

The table management unit 212 monitors an amount of written data for each of the SSDs to update the cumulative value of amount of written data stored in the SSD table 211b.

The table management unit 212 calculates an upper limit value and a cumulative value of each of the RAID groups on the basis of the upper limit value and the cumulative value of the respective SSDs stored in the SSD table 211b, and stores the calculated upper limit value and cumulative value in the RAID table 211a. The table management unit 212 calculates a threshold value on the basis of the upper limit value stored in the RAID table 211a, and stores the calculated threshold value in the RAID table 211a.

The command processing unit 213 performs a process in accordance with a command received from the host device 100. For example, upon receiving a read command from the host device 100, the command processing unit 213 reads data specified by the read command from an SSD and transmits the data read from the SSD to the host device 100. Further, upon receiving a write command including write data from the host device 100, the command processing unit 213 writes the received write data in an SSD and returns, to the host device 100, a response representing the completion of the writing.

The RAID controller 214 performs a process of adding an SSD to a RAID group or releasing an SSD from a RAID group. The RAID controller 214 performs the rearrangement between an SSD which belongs to a RAID group for which the rearrangement flag is ON, and an SSD which belongs to another RAID group. At this time, the RAID controller 214 performs data exchange between the SSDs by using the HS, and furthermore, performs controls for adding or releasing the SSDs with respect to the RAID groups.

The functions of the storage control device 200 have been described.

Subsequently, the flow of the processes performed by the storage control device 200 will be described.

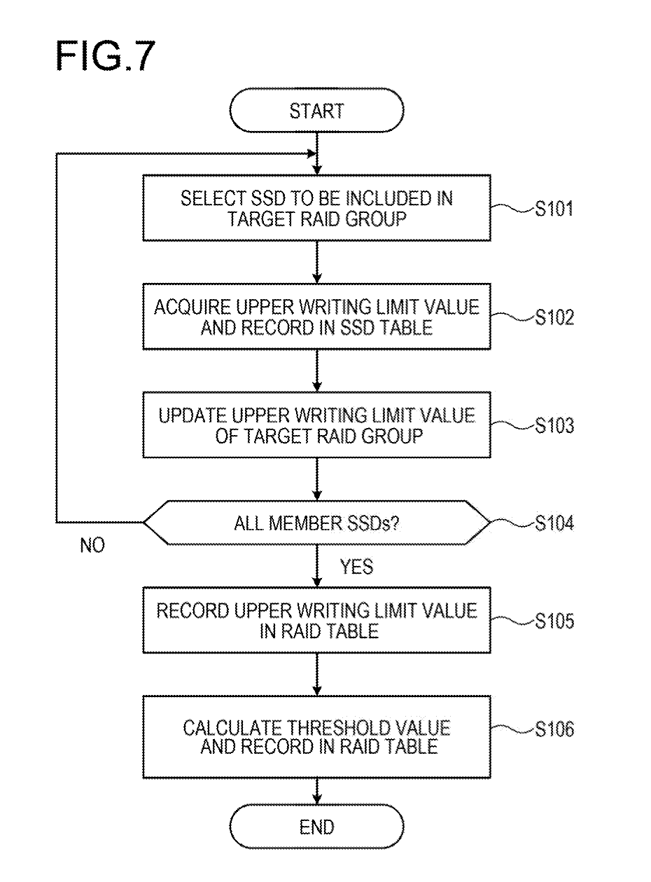

First, descriptions will be made on a process of constructing the RAID table 211a and the SSD table 211b when SSDs are added and a RAID group is defined, with reference to FIG. 7. FIG. 7 is a flowchart illustrating a table construction process according to the second embodiment.

(S101) The table management unit 212 selects, from the added SSDs, an SSD which is to be included in the RAID group (target RAID group) to be defined. Then, the table management unit 212 records identification information of the selected SSD in the “Member SSD” column of the SSD table 211b which corresponds to the target RAID group.

(S102) The table management unit 212 acquires an upper limit value (upper writing limit value) of amount of writable data from the selected SSD, and records the acquired upper writing limit value in the SSD table 211b.

(S103) The table management unit 212 adds the upper writing limit value of the selected SSD to the upper writing limit value of the target RAID group. The upper writing limit value of the target RAID group before the addition of the SSD may be acquired from the RAID table 211a.

(S104) The table management unit 212 determines whether the selection of the SSDs added as the member SDDs to the target RAID group has been completed. When it is determined that the selection of the member SSDs has been completed, the process proceeds to S105. When it is determined that a not-yet-selected member SSD exists, the process proceeds to S101.

(S105) The table management unit 212 records the upper writing limit value of the target RAID group in the RAID table 211a. That is, the table management unit 212 updates the upper writing limit value of the target RAID group stored in the RAID table 211a to reflect the upper writing limit value of the added member SSDs.

(S106) The table management unit 212 calculates a threshold value on the basis of the upper writing limit value of the target RAID group, and records the calculated threshold value in the RAID table 211a. In this way, the threshold value is calculated based on the upper writing limit value of the target RAID group. The threshold value is set to, for example, 70% of the upper writing limit value. However, the setting of the threshold value may be arbitrarily determined.

As described later, a RAID group having a large cumulative value of amount of written data is identified based on the threshold value, and a rearrangement to replace an SSD of the identified RAID group with a less consumed SSD is performed. Hence, by setting a low threshold value for a RAID group required to lower the risk of multiple failures in SSDs so as to increase the opportunity to perform the rearrangement, it is possible to contribute to the lowering of the risk.

For example, the threshold value may be set based on, for example, a concentration degree of access to the target RAID group or reliability expected from the target RAID group. More specifically, for example, it may be possible to adopt a method of setting a low threshold value for a RAID group to which an access is highly frequent or a RAID group which handles business application data requiring reliability.

When the process of S106 is completed, the series of processes illustrated in FIG. 7 are ended.

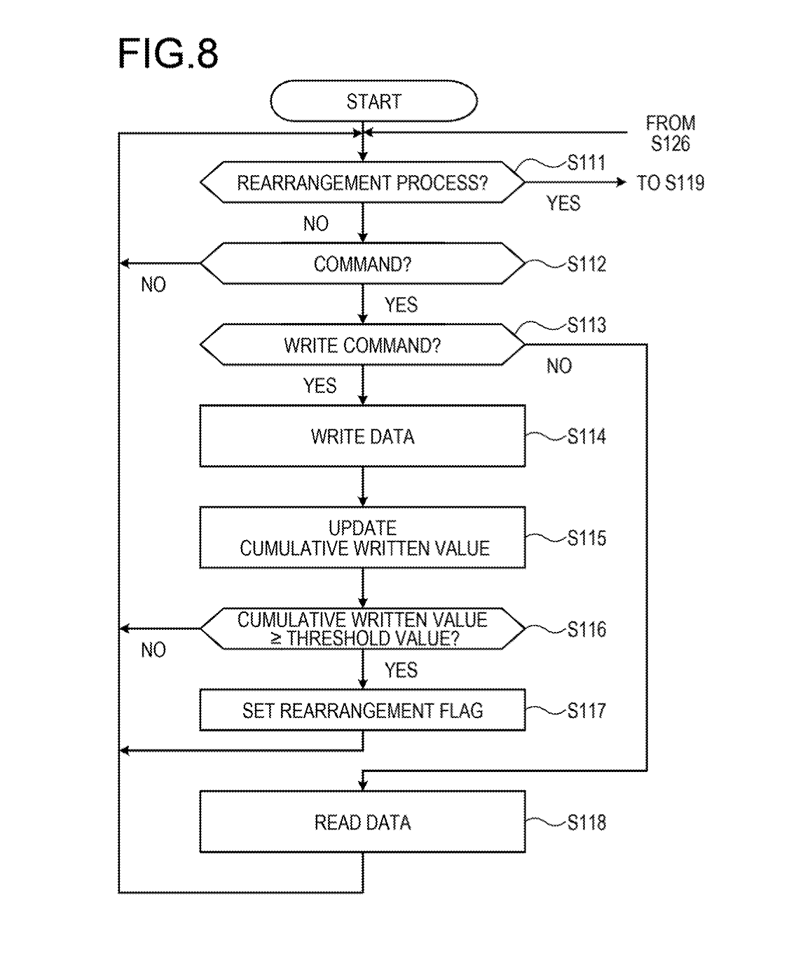

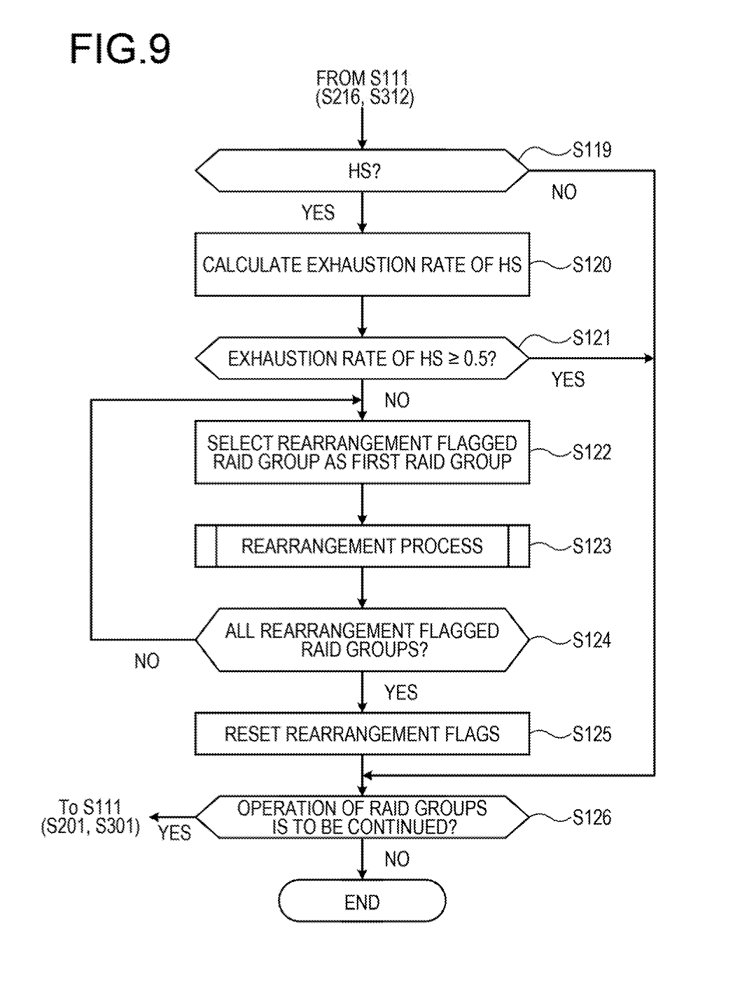

Subsequently, descriptions will be made on a flow of processes (processes for RAID groups in operation) performed during an operation of the constructed RAID groups with reference to FIGS. 8 and 9.

FIG. 8 is a first flowchart illustrating a flow of processes for RAID groups in operation according to the second embodiment. FIG. 9 is a second flowchart illustrating processes for RAID groups in operation according to the second embodiment.

(S111) The RAID controller 214 determines whether a timing (timing for rearrangement) for performing the rearrangement process has come. For example, the timing for rearrangement is set such that the rearrangement process is performed on a preset cycle (e.g., on a 15-day cycle when the operation time period is 5 years). The RAID controller 214 determines whether the timing for rearrangement has come, by determining whether a predetermined time period (e.g., 15 days) has elapsed from a timing of the operation start or the previous rearrangement process.

When it is determined that the timing for rearrangement has come, the process proceeds to S119 of FIG. 9. When it is determined that the timing for rearrangement has not yet come, the process proceeds to S112.

(S112) The command processing unit 213 determines whether a command has been received from the host device 100. When it is determined that a command has been received, the process proceeds to S113. When it is determined that no command has been received, the process proceeds to S111.

(S113) The command processing unit 213 determines whether the command received from the host device 100 is a write command. When it is determined that the received command is a write command, the process proceeds to S114. When it is determined that the received command is a read command, the process proceeds to S118.

(S114) The command processing unit 213 writes data in a RAID group in accordance with the write command received from the host device 100. Then, the command processing unit 213 returns, to the host device 100, a response representing the completion of the writing.

(S115) The table management unit 212 updates the cumulative value (cumulative written value) of amount of written data for the RAID group (target RAID group) in which data have been written by the command processing unit 213.

For example, the table management unit 212 acquires the cumulative written values from the respective member SSDs of the target RAID group, and records the acquired cumulative written values of the SSDs in the SSD table 211b. Further, the table management unit 212 records a sum of the cumulative written values acquired from the member SSDs in the RAID table 211a.

When the process of S115 is completed, the process proceeds to S116.

(S116) The RAID controller 214 determines whether the cumulative written value of the target RAID group is the threshold value or more, with reference to the RAID table 211a. When it is determined that the cumulative written value is the threshold value or more, the process proceeds to S117. When it is determined that the cumulative written value is less than the threshold value, the process proceeds to S111.

(S117) The RAID controller 214 sets the rearrangement flag of the target RAID group. That is, the RAID controller 214 causes the rearrangement flag for the target RAID group to be ON, and updates the RAID table 211a. When the process of S117 is completed, the process proceeds to S111.

(S118) The command processing unit 213 reads data from a RAID group in accordance with the read command received from the host device 100. Then, the command processing unit 213 transmits the data read from the RAID group to the host device 100. When the process of S118 is completed, the process proceeds to S111.

(S119) The RAID controller 214 determines whether the HS exists. When it is determined that the HS exists, the process proceeds to S120. When it is determined that no HS exists, the process proceeds to S126. For example, in the example of FIG. 4, the SSD 305 is set as the HS. In this case, the process proceeds to S120.

(S120) The RAID controller 214 acquires the upper writing limit value and the cumulative written value of the HS with reference to the SSD table 211b. Then, the RAID controller 214 calculates an exhaustion rate of the HS. The exhaustion rate is obtained by, for example, dividing the cumulative written value by the upper writing limit value (cumulative value/upper limit value).

(S121) The RAID controller 214 determines whether the exhaustion rate of the HS is 0.5 or more. When it is determined that the exhaustion rate of the HS is 0.5 or more, the process proceeds to S126. When it is determined that the exhaustion rate of the HS is less than 0.5, the process proceeds to S122.

The value 0.5 for evaluating the exhaustion rate of the HS may be arbitrarily changed. For example, this value may be set to a ratio (threshold value/cumulative written value) of the threshold value and the cumulative written value that are described in the RAID table 211a. The processes of S120 and S121 are intended to suppress the risk of the simultaneous occurrence of failures in the plurality of SSDs including the HS during the rearrangement process, in consideration of the consumption of the HS.

(S122) With reference to the RAID table 211a, the RAID controller 214 identifies a RAID group (rearrangement flagged RAID group) for which the rearrangement flag is ON. Then, the RAID controller 214 selects the rearrangement flagged RAID group as a first RAID group. The first RAID group is a RAID group having a large cumulative written value.

(S123) The RAID controller 214 performs the rearrangement process. During the process, the RAID controller 214 selects an SSD of the first RAID group and replaces data between the selected SSD and an SSD of a RAID group different from the first RAID group. Then, the RAID controller 214 exchanges the RAID groups to which the SSDs belong. The rearrangement process will be further described later.

(S124) The RAID controller 214 determines whether the selection of all the rearrangement flagged RAID groups has been completed. When it is determined that the selection of all the rearrangement flagged RAID groups has been completed, the process proceeds to S125. When it is determined that a not-yet-selected rearrangement flagged RAID group exists, the process proceeds to S122.

(S125) The RAID controller 214 resets the rearrangement flags. That is, the RAID controller 214 causes all the rearrangement flags in the RAID table 211a to be OFF.

(S126) The RAID controller 214 determines whether the preset operation time period has been expired. When it is determined that the operation time period has not been expired, that is, the operation of the RAID groups is to be continued, the process proceeds to S111 of FIG. 8. When it is determined that the operation time period has been expired so that the operation of the RAID groups is to be stopped, the series of processes illustrated in FIGS. 8 and 9 are ended.

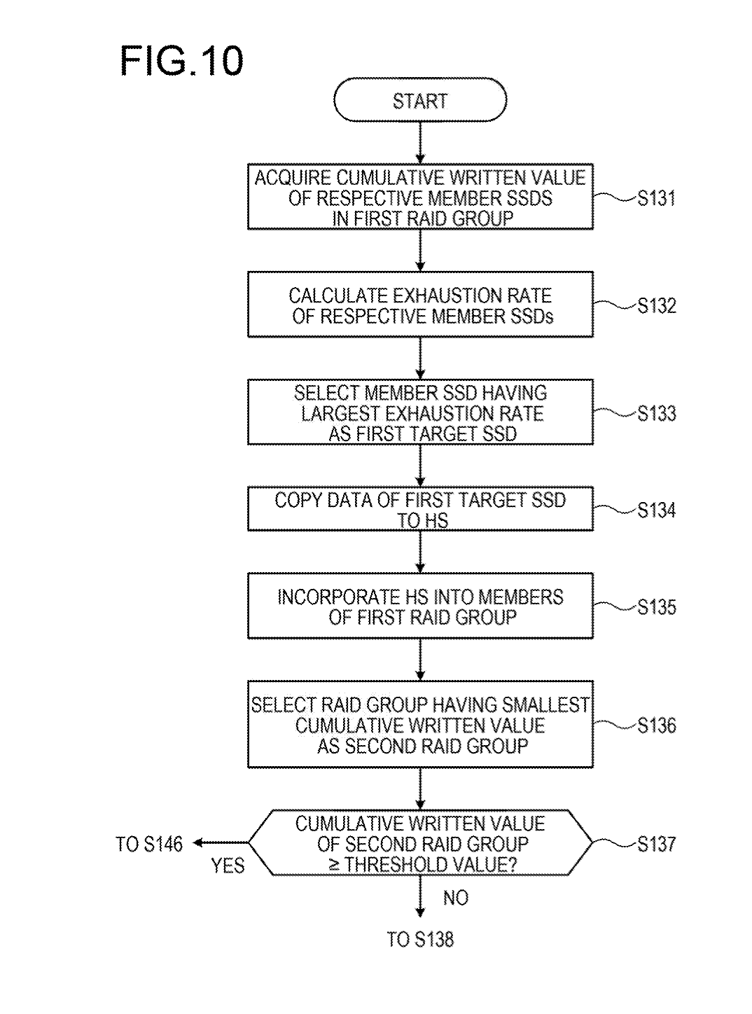

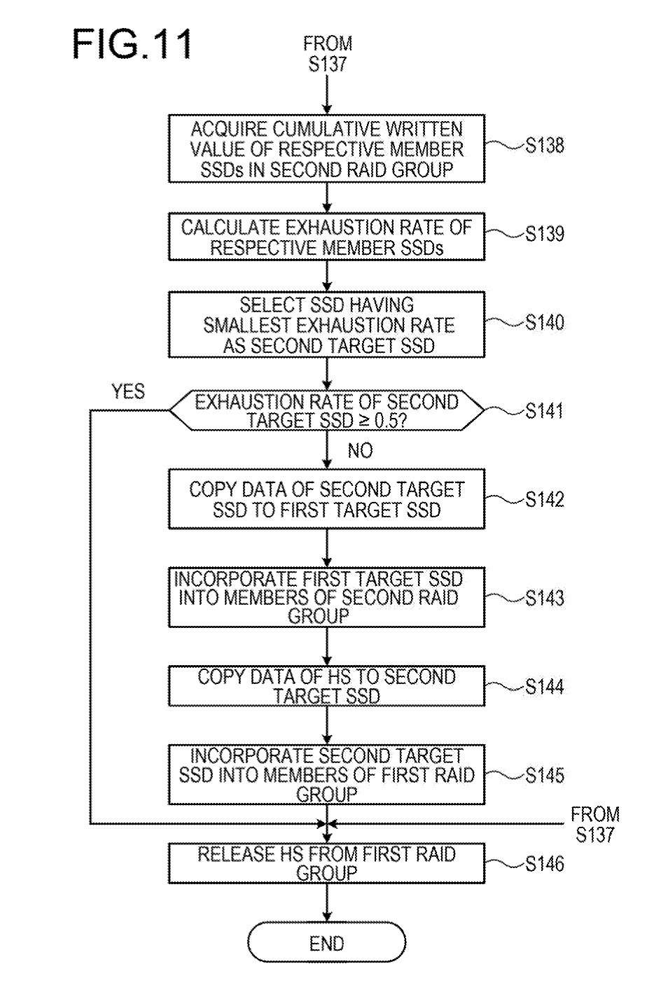

Here, the flow of the rearrangement process (S123) will be further described with reference to FIGS. 10 and 11.

FIG. 10 is a first flowchart illustrating a flow of the rearrangement process according to the second embodiment. FIG. 11 is a second flowchart illustrating a flow of the rearrangement process according to the second embodiment.

(S131) The RAID controller 214 acquires the cumulative written values of the respective member SSDs which belong to the first RAID group with reference to the SSD table 211b.

(S132) The RAID controller 214 acquires the upper writing limit values from the SSD table 211b, and calculates an exhaustion rate of the respective member SSDs which belong to the first RAID group on the basis of the upper writing limit value and the cumulative written value. The exhaustion rate is obtained, for example, by dividing the cumulative written value by the upper writing limit value (cumulative value/upper limit value).

(S133) The RAID controller 214 selects a member SSD having the largest exhaustion rate as a first target SSD from the member SSDs which belong to the first RAID group.

(S134) The RAID controller 214 copies data of the first target SSD to the HS.

(S135) The RAID controller 214 incorporates the HS to which the data has been copied in S134 into the members of the first RAID group. The RAID controller 214 releases the first target SSD from the first RAID group. The RAID controller 214 may use the incorporated HS, in place of the first target SSD, so as to continue the operation of the first RAID group.

(S136) The RAID controller 214 selects a RAID group having the smallest cumulative written value as a second RAID group from RAID groups other than the first RAID group.

(S137) The RAID controller 214 determines whether the cumulative written value of the second RAID group is the threshold value or more, with reference to the RAID table 211a. When it is determined that the cumulative written value is the threshold value or more, the process proceeds to S146 of FIG. 11. When it is determined that the cumulative written value is less than the threshold value, the process proceeds to S138 of FIG. 11.

The effect of distributing the consumption burden is small when the rearrangement is performed between RAID groups having large cumulative written values. Hence, it is required to avoid the data writing due to the rearrangement process and not to cause each SSD to be consumed. Thus, the determination process of S137 is provided to suppress the rearrangement of SSDs between RAID groups having large cumulative written values.

(S138) The RAID controller 214 acquires cumulative written values of the respective member SSDs which belong to the second RAID group with reference to the SSD table 211b.

(S139) The RAID controller 214 acquires upper writing limit values from the SSD table 211b, and calculates an exhaustion rate of each of the member SSDs which belong to the second RAID group on the basis of the upper writing limit values and the cumulative written values.

(S140) The RAID controller 214 selects a member SSD having the smallest exhaustion rate as a second target SSD from the member SSDs which belong to the second RAID group.

(S141) The RAID controller 214 determines whether the exhaustion rate of the second target SSD is 0.5 or more. When it is determined that the exhaustion rate of the second target SSD is 0.5 or more, the process proceeds to S146. When it is determined that the exhaustion rate of the second target SSD is less than 0.5, the process proceeds to S142. The value 0.5 for evaluating the exhaustion rate of the second target SSD may be arbitrarily changed.

The effect in distributing the consumption burden is small when the rearrangement is performed between SSDs having large cumulative written values. Hence, it is required to avoid the data writing due to the rearrangement process and not to cause each SSD to be consumed. Thus, the determination process of S141 is provided to suppress the rearrangement between SSDs having large cumulative written values.

(S142) The RAID controller 214 copies the data of the second target SSD to the first target SSD. The data of the first target SSD has already been copied to the HS and is left in the HS even when the first target SSD is overwritten by the data of the second target SSD.

(S143) The RAID controller 214 incorporates the first target SSD into the members of the second RAID group. Then, the RAID controller 214 releases the second target SSD from the second RAID group, and operates the first target SSD in place of the second target SSD.

(S144) The RAID controller 214 copies the data of the HS to the second target SSD. That is, the data previously held in the first target SSD serving as a member of the first RAID group is copied to the second target SSD through the HS.

(S145) The RAID controller 214 incorporates the second target SSD into the members of the first RAID group.

(S146) The RAID controller 214 releases the HS from the first RAID group.

When the second target SSD is incorporated into the first RAID group, the second target SSD is operated as a member of the first RAID group in place of the released HS. When the second target SSD is not included in the first RAID group (when the process proceeds to S146 from S137 or S141), the RAID controller 214 returns the first target SSD to be a member of the first RAID group and releases the HS from the first RAID group.

When the process of S146 is completed, the series of processes illustrated in FIGS. 10 and 11 are ended.

In the above-described example, the RAID group having the smallest cumulative written value is selected as the second RAID group. However, for example, a RAID group having the smallest exhaustion rate may be selected. Alternatively, an arbitrary RAID group having a smaller cumulative written value or exhaustion rate than that of the first RAID group may be selected as the second RAID group.

In the above-described example, the SSD having the smallest exhaustion rate is selected as the second target SSD. However, for example, an SSD randomly selected from the second RAID group may be selected as the second target SSD. In the above-described example, the cumulative written value of a RAID group is a total cumulative written value of the member SSDs. However, an average cumulative written value of the member SSDs may be used. These modifications are also included in the technological scope of the second embodiment.

Subsequently, a modification (Modification#1) of the second embodiment will be described. Modification#1 is configured to frequently perform a process of checking a cumulative written value for a RAID group having a large cumulative written value. Since the above-described processes of FIG. 9 are not modified, overlapping descriptions thereof may be omitted by referring to FIG. 9.

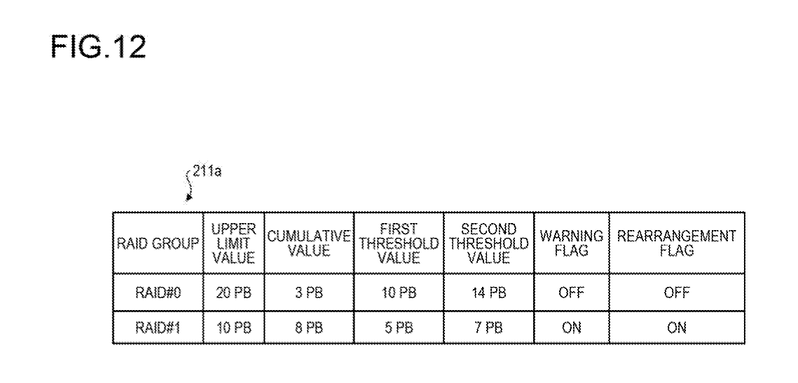

In Modification#1, the RAID table 211a is partially modified. FIG. 12 is a diagram illustrating an example of a RAID table according to a modification (Modification#1) of the second embodiment. As illustrated in FIG. 12, the RAID table 211a according to Modification#1 includes a first threshold value (“First Threshold Value” column), a second threshold value (“Second Threshold Value” column), and a warning flag (“Warning Flag” column). The warning flag is information indicating a candidate for a RAID group to be rearranged. The first threshold value is used to determine whether or not to set a warning flag. The second threshold value is used to determine whether or not to set a rearrangement flag. The first threshold value is set to be smaller than the second threshold value.

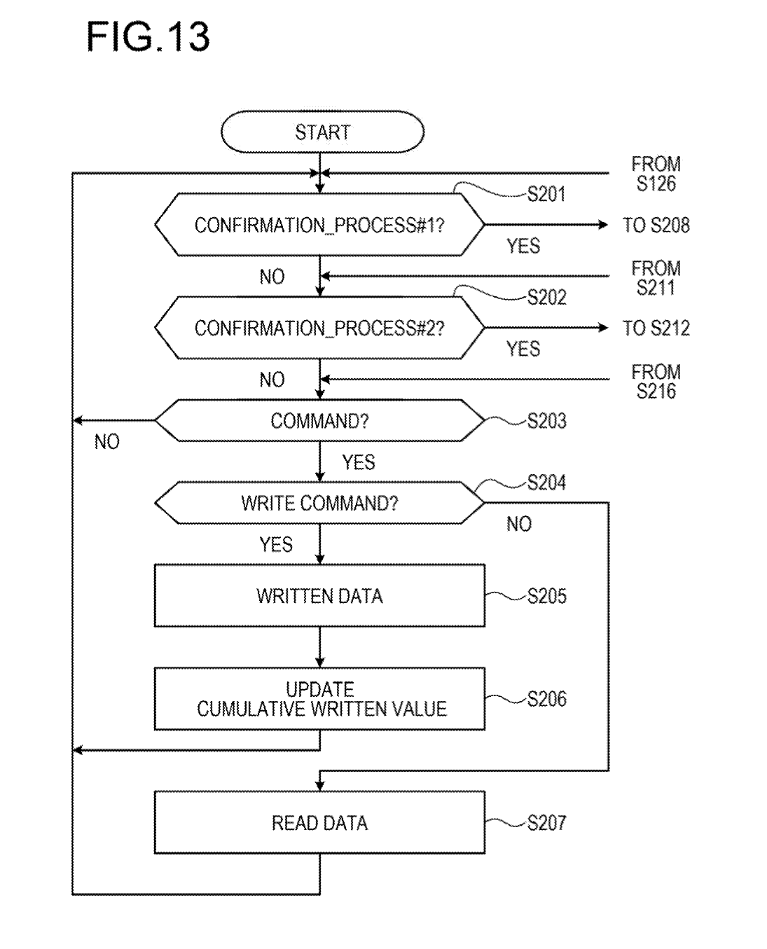

Processes for RAID groups in operation according to Modification#1 will be described with reference to FIGS. 13 to 15.

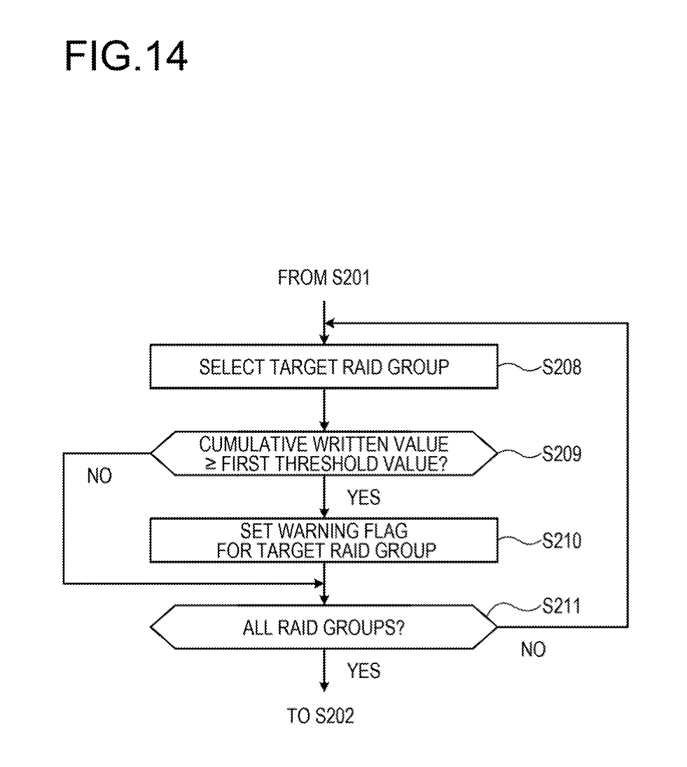

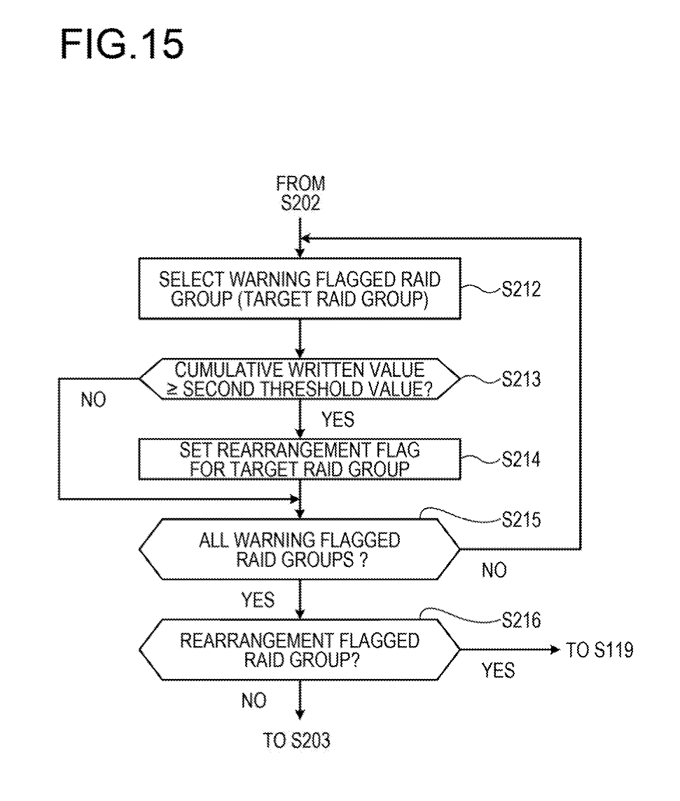

FIG. 13 is a first flowchart illustrating a flow of processes for RAID groups in operation according to Modification#1 of the second embodiment. FIG. 14 is a second flowchart illustrating a flow of processes for RAID groups in operation according to Modification#1 of the second embodiment. FIG. 15 is a third flowchart illustrating a flow of processes for RAID groups in operation according to Modification#1 of the second embodiment.

(S201) The RAID controller 214 determines whether a timing to perform a confirmation process (confirmation_process#1) for confirming all RAID groups has come. For example, the timing is set such that confirmation_process#1 is performed on a preset cycle (e.g., on a 15-day cycle when the operation time period is 5 years). Confirmation_process#1 is a process of confirming whether a candidate (RAID group to which the warning flag is set) for a RAID group to be rearranged exists.

The RAID controller 214 determines whether the timing to perform confirmation_process#1 has come, by determining whether a predetermined time cycle (e.g., 15 days) has elapsed from a timing of the operation start or previous confirmation_process#1. When it is determined that the timing to perform confirmation_process#1 has come, the process proceeds to S208 of FIG. 14. When it is determined that the timing to perform confirmation_process#1 has not come, the process proceeds to S202.

(S202) The RAID controller 214 determines whether a timing to perform a confirmation process (confirmation_process#2) for confirming RAID groups (warning flagged RAID groups) to which the warning flag has been set has come. When no warning flagged RAID group exists, the process of S202 is skipped, and the process proceeds to S203.

For example, the timing to perform confirmation_process#2 is set such that confirmation_process#2 is performed on a preset cycle. The cycle of performing confirmation_process#2 is set to be shorter (e.g., 7.5-day cycle) than the cycle of performing confirmation_process#1 (e.g., 15-day cycle).

Confirmation_process#2 is a process of confirming whether a RAID group to be rearranged exists among the warning flagged RAID groups.

The RAID controller 214 determines whether the timing to perform confirmation_process#2 has come, by determining whether a predetermined time cycle (e.g., 7.5 days) has elapsed from a timing of the operation start or previous confirmation_process#2. When it is determined that the timing to perform confirmation_process#2 has come, the process proceeds to S212 of FIG. 15. When it is determined that the timing to perform confirmation_process#2 has not come, the process proceeds to S203.

(S203) The command processing unit 213 determines whether a command has been received from the host device 100. When it is determined that a command has been received, the process proceeds to S204. When it is determined that no command has been received, the process proceeds to S201.

(S204) The command processing unit 213 determines whether the command received from the host device 100 is a write command. When it is determined that the received command is a write command, the process proceeds to S205. When it is determined that the received command is a read command, the process proceeds to S207.

(S205) The command processing unit 213 writes data in a RAID group in accordance with the write command received from the host device 100. Then, the command processing unit 213 returns, to the host device 100, a response representing the completion of the writing.

(S206) The table management unit 212 updates a cumulative written value for the RAID group (target RAID group) in which the data has been written by the command processing unit 213.

For example, the table management unit 212 acquires the cumulative written values from the respective member SSDs of the target RAID group, and records the acquired cumulative written values of the SSDs in the SSD table 211b. Further, the table management unit 212 records a sum of the cumulative written values acquired from the member SSDs in the RAID table 211a.

When the process of S206 is completed, the process proceeds to S201.

(S207) The command processing unit 213 reads data from a RAID group in accordance with the read command received from the host device 100. Then, the command processing unit 213 transmits the data read from the RAID group to the host device 100. When the process of S207 is completed, the process proceeds to S201.

(S208) The RAID controller 214 selects one RAID group (target RAID group).

(S209) The RAID controller 214 determines whether the cumulative written value of the target RAID group is the first threshold value or more, with reference to the RAID table 211a. When it is determined that the cumulative written value is the first threshold value or more, the process proceeds to S210. When it is determined that the cumulative written value is less than the first threshold value, the process proceeds to S211.

(S210) The RAID controller 214 sets a warning flag for the target RAID group. That is, the RAID controller 214 causes the warning flag of the target RAID group to be ON so as to update the RAID table 211a.

(S211) The RAID controller 214 determines whether the selection of all RAID groups has been completed. When it is determined that the selection of all RAID groups has been completed, the process proceeds to S202 of FIG. 13. When it is determined that a not-yet-selected RAID group exists, the process proceeds to S208.

(S212) The RAID controller 214 selects one warning flagged RAID group (target RAID group).

(S213) The RAID controller 214 determines whether the cumulative written value of the target RAID group is the second threshold value or more, with reference to the RAID table 211a. When it is determined that the cumulative written value is the second threshold value or more, the process proceeds to S214. When it is determined that the cumulative written value is less than the threshold value, the process proceeds to S215.

(S214) The RAID controller 214 sets a rearrangement flag for the target RAID group. That is, the RAID controller 214 causes the rearrangement flag of the target RAID group to be ON so as to update the RAID table 211a.

(S215) The RAID controller 214 determines whether the selection of all the warning flagged RAID groups has been completed. When it is determined that the selection of all the warning flagged RAID groups has been completed, the process proceeds to S216. When it is determined that a not-yet-selected warning flagged RAID group exists, the process proceeds to S212.

(S216) The RAID controller 214 determines whether a rearrangement flagged RAID group exists, with reference to the RAID table 211a. When it is determined that a rearrangement flagged RAID group exists, the process proceeds to S119 of FIG. 9. When it is determined that no rearrangement flagged RAID group exists, the process proceeds to S203. In the case of Modification#1, when it is determined in S126 of FIG. 9 that the operation of the RAID groups is to be continued, the process proceeds to S201.

According to Modification#1, a warning flag is assigned to a RAID group which has been consumed, and the cumulative written value of the RAID group is checked per relatively short time interval so that it is possible to reduce the risk of the multiple failures occurring in a time period when the checking process is not performed. Further, since the checking process is performed for a RAID group which has been less consumed per relatively long time interval, the burden to perform the checking process may be suppressed.

Subsequently, another modification (Modification#2) of the second embodiment will be described. Modification#2 is configured to estimate a cumulative written value of a RAID group at the expiration time of the operation time period, based on a variation of the cumulative written value, and determine the necessity/unnecessity of the rearrangement on the basis of the estimation result. Since the processes of FIG. 9 are not modified, overlapping descriptions thereof may be omitted by referring to FIG. 9.

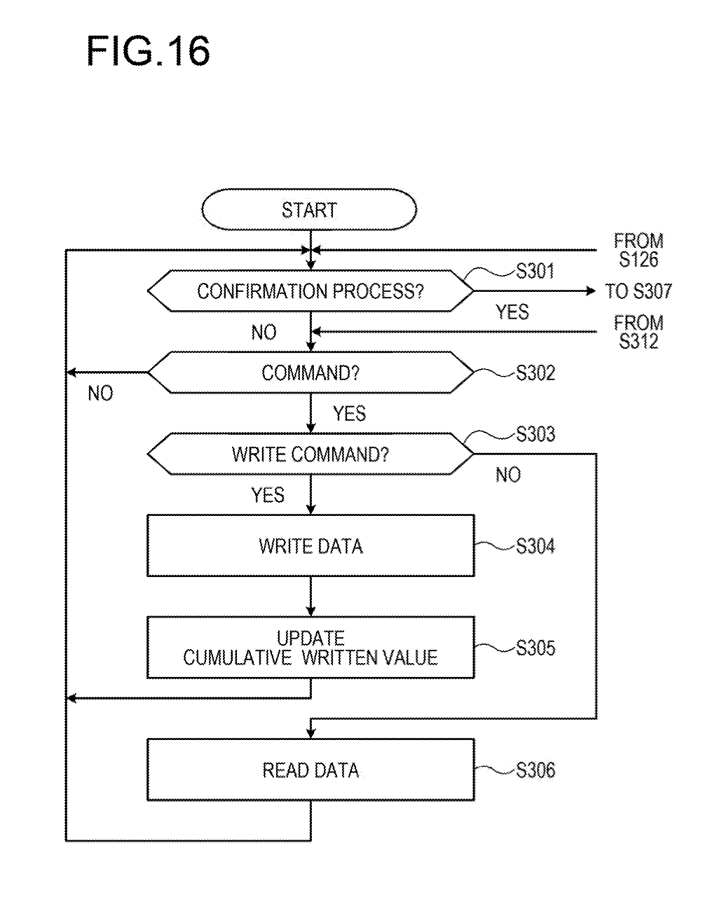

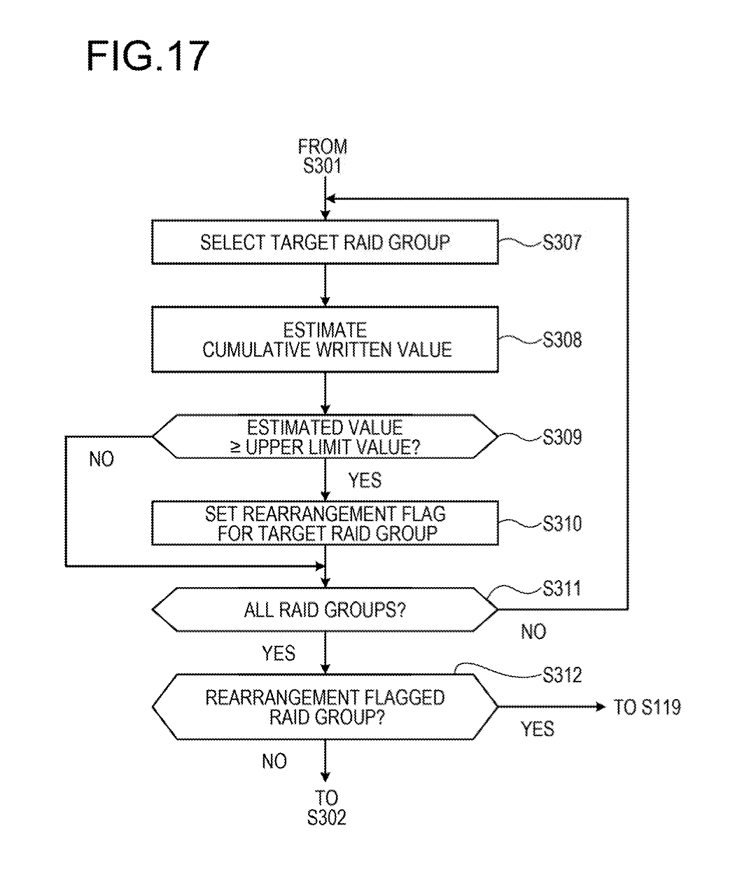

Processes for RAID groups in operation according to Modification#2 will be described with reference to FIGS. 16 and 17.

FIG. 16 is a first flowchart illustrating a flow of processes for RAID groups in operation according to Modification#2 of the second embodiment. FIG. 17 is a second flowchart illustrating a flow of processes for RAID groups in operation according to Modification#2 of the second embodiment.

(S301) The RAID controller 214 determines whether a timing to perform the confirmation process to confirm whether a RAID group to be rearranged exists has come. For example, the timing for rearrangement is set such that the confirmation process is performed on a preset cycle (e.g., on a 15-day cycle when the operation time period is 5 years). When it is determined that the timing to perform the confirmation process has come, the process proceeds to S307 of FIG. 17. When it is determined that the timing to perform the confirmation process has not come, the process proceeds to S302.

(S302) The command processing unit 213 determines whether a command has been received from the host device 100. When it is determined that a command has been received, the process proceeds to S303. When it is determined that no command has been received, the process proceeds to S301.

(S303) The command processing unit 213 determines whether the command received from the host device 100 is a write command. When it is determined that the received command is a write command, the process proceeds to S304. When it is determined that the received command is a read command, the process proceeds to S306.

(S304) The command processing unit 213 writes data in a RAID group in accordance with the write command received from the host device 100. Then, the command processing unit 213 returns, to the host device 100, a response representing the completion of the writing.

(S305) The table management unit 212 updates a cumulative written value for the RAID group (target RAID group) in which the data has been written by the command processing unit 213.

For example, the table management unit 212 acquires cumulative written values from the respective member SSDs of the target RAID group, and records the acquired cumulative written values of the SSDs in the SSD table 211b. Further, the table management unit 212 records a sum of the cumulative written values acquired from the member SSDs in the RAID table 211a.

When the process of S305 is completed, the process proceeds to S301.

(S306) The command processing unit 213 reads data from a RAID group in accordance with the read command received from the host device 100. Then, the command processing unit 213 transmits the data read from the RAID group to the host device 100. When the process of S306 is completed, the process proceeds to S301.

(S307) The RAID controller 214 selects one RAID group (target RAID group). At this time, the RAID controller 214 stores the cumulative written value of the target RAID group in the storage unit 211, with reference to the RAID table 211a.

(S308) The RAID controller 214 estimates a cumulative written value of the target RAID group at the expiration time of the operation time period on the basis of an increase amount of the cumulative written value from the previous confirmation process. The operation time period (e.g., 5 years) is preset.

For example, the RAID controller 214 calculates, as the increase amount of the cumulative written value, a difference between the cumulative written value stored in the storage unit 211 in the process of S307 in a previous confirmation process and the cumulative written value currently stored in the RAID table 211a. The RAID controller 214 calculates an increase amount of written data per unit time on the basis of the cycle of the confirmation process and the calculated increase amount of the cumulative written value.

Further, the RAID controller 214 calculates the rest of the operation time period on the basis of a time elapsed from the operation start time. Then, the RAID controller 214 estimates a cumulative written value at the expiration time of the operation time period on the basis of the calculated increase amount of the cumulative written value per unit time, the calculated rest of the operation time period, and the current cumulative written value. That is, the RAID controller 214 calculates, as an estimated value, a cumulative written value at the expiration time of the operation time period in a case where it is assumed that the cumulative value of amount of written data has increased by the calculated increase amount of the cumulative written value per unit time.

(S309) The RAID controller 214 compares the estimated value calculated in S308 and the upper writing limit value stored in the RAID table 211a with each other to determine whether the estimated value is the upper writing limit value or more. When it is determined that the estimated value is the upper writing limit value or more, the process proceeds to S310. When it is determined that the estimated value is less than the upper writing limit value, the process proceeds to S311.

(S310) The RAID controller 214 assigns a rearrangement flag to a target RAID group. That is, the RAID controller 214 causes the rearrangement flag of the target RAID group to be ON to update the RAID table 211a.

(S311) The RAID controller 214 determines whether the selection of all the RAID groups has been completed. When it is determined that the selection of all the RAID groups has been completed, the process proceeds to S312. When it is determined that a not-yet-selected RAID group exists, the process proceeds to S307.

(S312) The RAID controller 214 determines whether a rearrangement flagged RAID group exists. When it is determined that a rearrangement flagged RAID group exists, the process proceeds to S119 of FIG. 9. When it is determined that no rearrangement flagged RAID group exists, the process proceeds to S302 of FIG. 16. In the case of Modification#2, when it is determined in S126 of FIG. 9 that the operation of the RAID groups is to be continued, the process proceeds to S301.

According to Modification#2, by estimating the risk of occurrence of failures in SSDs during the operation time period to avoid the rearrangement process when it is estimated that no failure is to occur, it is possible to suppress the increase of the process burden due to the rearrangement process or the consumption of SSDs.

The second embodiment has been described. In the second embodiment, an example using an SSD-RAID has been described. However, the present disclosure may be similarly applied to a storage system using a storage medium having an upper limit of a cumulative written value, in addition to SSDs.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage control device, comprising:
a memory configured to
store therein first information about a cumulative amount of data which has been written into a plurality of storage devices respectively, the plurality of storage devices having a limit in a cumulative amount of data which is capable to be written into the respective storage devices, the plurality of storage devices being grouped into a plurality of storage groups; and
a processor coupled with the memory and the processor configured to
select a first storage group from the plurality of storage groups on basis of the first information,
select a second storage group from the plurality of storage groups, the second storage group being different from the first storage group,
exchange data of a first storage device which belongs to the first storage group and data of a second storage device which belongs to the second storage group with each other,
cause the first storage device to belong to the second storage group, and
cause the second storage device to belong to the first storage group.

2. The storage control device according to claim 1, wherein
the first information includes a threshold value to be compared with a group sum calculated for the respective storage groups, the group sum being a sum of cumulative amounts of data which has been written into storage devices which belong to the respective storage groups, and
the processor is configured to
calculate the group sum for the respective storage groups, and
select, as the first storage group, a storage group having a group sum which is larger than the threshold value from the plurality of storage groups.

3. The storage control device according to claim 2, wherein
the processor is configured to
select, as the second storage group, a storage group having a smallest group sum from the plurality of storage groups.

4. The storage control device according to claim 1, wherein
the processor is configured to
calculate a first evaluation value for the respective storage devices which belong to the first storage group, the first evaluation value indicating a degree of the cumulative amount of data which has been written into the respective storage devices which belong to the first storage group,
select, as the first storage device, a storage device having a largest first evaluation value,
calculate a second evaluation value for the respective storage devices which belong to the second storage group, the second evaluation value indicating a degree of the cumulative amount of data which has been written into the respective storage devices which belong to the second storage group, and
select, as the second storage device, a storage device having a smallest second evaluation value.

5. The storage control device according to claim 4, wherein
the processor is configured to
obtain the first evaluation value by dividing the cumulative amount of data which has been written into the respective storage devices which belong to the first storage group by the limit.

6. A non-transitory computer-readable recording medium having stored therein a program that causes a computer to execute a process, the process comprising:
selecting a first storage group from a plurality of storage groups on basis of first information, the first information being about a cumulative amount of data which has been written into a plurality of storage devices respectively, the plurality of storage devices having a limit in a cumulative amount of data which is capable to be written into the respective storage devices, the plurality of storage devices being grouped into the plurality of storage groups;
selecting a second storage group from the plurality of storage groups, the second storage group being different from the first storage group;
exchanging data of a first storage device which belongs to the first storage group and data of a second storage device which belongs to the second storage group with each other;
causing the first storage device to belong to the second storage group; and
causing the second storage device to belong to the first storage group.
